(19) United States
(12) Patent Application Publication
(10) Pub. No.: US 2014/0032712 A1
(43) Pub. Date: Jan. 30, 2014

(54) SYSTEM AND METHOD FOR IDENTIFYING THE LAST RELEVANT PAGE IN A DIGITAL PUBLICATION

(71) Applicant: barnesandnoble.com llc, New York, NY (US)

(72) Inventors: Roger Robert WEBSTER, Los Altos, CA (US); Jamie IANNONE, Summit, NJ (US)

(73) Assignee: barnesandnoble.com llc, New York, NY (US)

(21) Appl. No.: 13/951,183

(22) Filed: Jul. 25, 2013

Related U.S. Application Data
(60) Provisional application No. 61/676,174, filed on Jul. 26, 2012.

(51) Int. Cl. H04L 29/08

(52) U.S. Cl. CPC H04L 67/02
USPC 709/217

(57) ABSTRACT

A system and method for use in connection with a reader for digital publication, such as electronic books, eBooks. The system and method identifies the last interesting or relevant page as the page at which most readers will exit the electronic book and never open it again. An element can be placed on last interesting page that will engage the user in further reading experiences. Users' devices that are registered in the system keep track of the last page viewed by a user in a digital publication. This data is fed back to a central server. Collecting the same data from multiple users reading the same digital publication, the system is able to statistically determine the last interesting page for that digital publication. The determined last interesting page is then fed back to the users for inclusion in the metadata of the digital publication and the device can insert the functional element at that page in the publication.

### FIELD OF THE INVENTION

The present invention generally relates to digital publications, and more particularly to systems and methods that enable the identification of the last interesting or relevant page in a digital publication.

### BACKGROUND OF THE INVENTION

A digital book, similar to its print counterpart, especially fiction content, has certain sections or pages at the end of the book, after last page of the main story. These additional sections or pages may contain, but are not limited to an “Afterword”, “Index”, “Errata”, “Credits”, “Acknowledgements”, “Back Flap”, “Appendices”, “End Notes”, “Glossary” etc. Often, these additional sections or pages extend way past the last page of the main story or the last page of the actual compelling content. Most users don't typically read past the last interesting/relevant page. In the print world, there was no need to specifically identify the last interesting page, as all of the pages in the print book are presented in “parallel” in comparison to the “serial” presentation of pages in an electronic publication.

### SUMMARY OF THE INVENTION

The present invention operates in connection with a reader for digital publication, such as electronic books, eBooks. Unlike in print publications, electronic publications are mostly presented in a serial fashion, page by page, to a user. Although most electronic reader applications have a Table of Contents type function, where a user can skip to certain chapters or sections, use of this function typically requires exiting the reading experience, bringing up the Table of Contents menu, clicking on the link to the desired section and being brought to the desired chapter, section or page. Although applicable to other types of digital publications, such as periodicals, the present invention is particularly applicable to eBooks.

Due to this predominately serial type presentation of electronic publications, it is desirable for publishers, distributors and retailers of electronic books and electronic book readers to be able to recognize the last interesting or relevant page in an eBook. Specifically, the last interesting or relevant page is the page at which most readers will exit the electronic book and never open it again. Users' devices that are registered in the system keep track of the last page viewed by a user in a digital publication. This data is fed back to a central server when the users' devices connect to the central server. The central server collects the same data from multiple users reading the same digital publication. Once collected, the system uses the last viewed page data from a wide spectrum of users to determine a statistically significant value for the last interesting page for that digital publication. The determined last interesting page is then fed back to the users for inclusion in the metadata of the digital publication. Additionally, the last interesting page value is associated with the master copy of the digital publication on the central server.

One significant reason for the being able to the identify the last interesting page is so that the publishers, distributors or retailers can position an element in the last interesting page that will engage the user in further reading experiences. For example, the element inserted on the last interesting page can engage the user in future content through advertisements or rewards and/or extend the current reading experience by offering similar content for preview or purchase. The element can also be used to get feedback directly from the user in regard to the content she has just read or engage the user to share thoughts on a social network.

The element positioned on the identified last interesting page are not limited to showing promotions. The element can also refer to a quiz, a feed back, more information about the author, other books by the same author, next book in the series, coupon information and much more. The element can be presented to the user generally in the form of a graphics overlay which can also be interactive.

This element placed on the last interesting page and its functions can provide a, personal feel to the user of how the reading ecosystem understands and appreciates its audience.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates an exemplary system according to the present invention;

FIG. 2 depicts graph plotting the number of users and the last page they visited before closing a publication;

FIG. 3 illustrates a flow chart of a preferred method of the present invention; and

FIG. 4 illustrates the components of an exemplary device.

### DETAILED DESCRIPTION OF THE INVENTION

The advent of electronic reader, which allows users to read books, periodicals, or whatever other material that had previously been available only through printed medium, opens new worlds of opportunity for interaction regarding the written word. Although much of the present disclosure references electronic books, as appreciated by those skilled in the art, the teachings herein are equally applicable to other forms of digital publications such as magazines, newspapers, journals . . . .

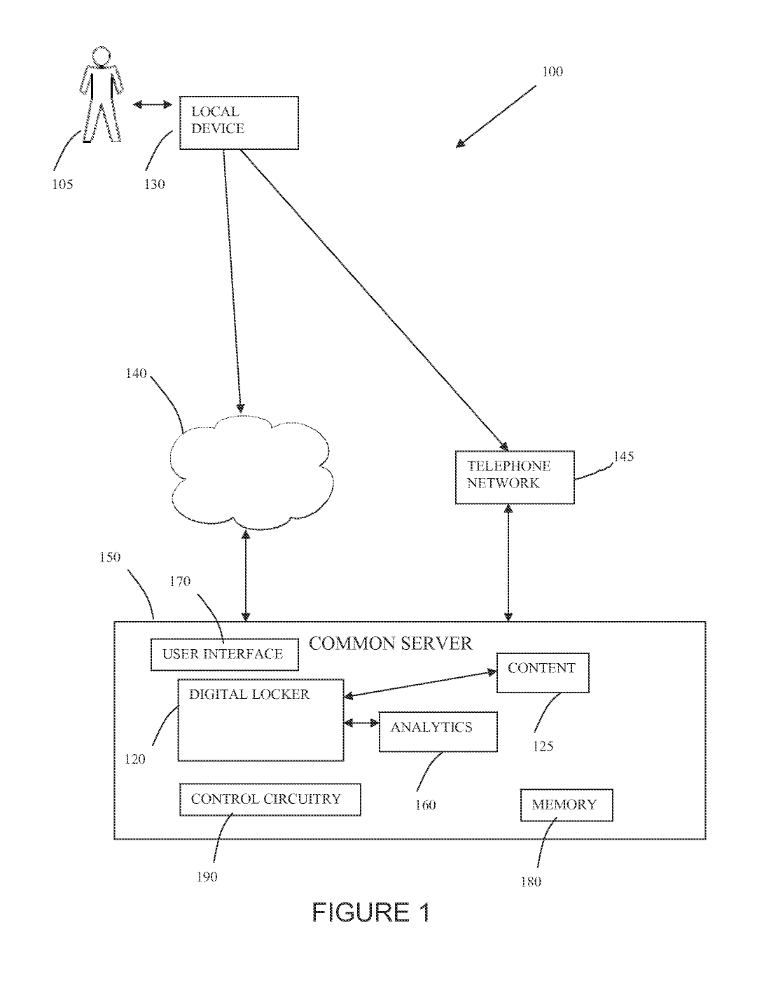

The present invention operates in conjunction with several components including, for example, the electronic publication itself, the software application for reading the electronic publications, the electronic reader device and preferably a remote server system, also known as the “cloud,” FIG. 1 illustrates an exemplary system according to the present invention,

FIG. 1 shows components of an exemplary system according to the present invention. User 105 is an authorized user of system 100 and uses her local device 130 for the reading of digital content. Many of the functions of system 100 of the present invention are carried out on server 150. As appreciated by those skilled in the art, many of the functions described herein can be divided between the server 150 and the user's local device 130. Further, as also appreciated by those skilled in the art, server 150 can be considered a “cloud” with respect to the user and her local device 130. The cloud can actually be comprised of several servers performing interconnected and distributed functions (e.g., web interfaces, storage . . . ). For the sake of simplicity in the present discussion, only a single server 150 will be described. The user 105 can connect to the server 150 via the Internet 140, a telephone network 145 (e.g., wirelessly through a cellphone network) or other suitable electronic communication means. User 105 has an account on lending server 150, which authorizes user 105 to use system 100.

Associated with the user's 105 account is the user's 105 digital locker 120 located on the server 150. As further described below, in the preferred embodiment of the present invention, digital locker 120 contains links to copies of digital content 125 previously purchased (or otherwise legally acquired) by user 105.

Indicia of rights to all copies of digital content 125 owned by user 105, including digital content 125, is stored by reference in digital locker 120. Digital locker 120 is a remote online repository that is uniquely associated with the user's 105 account. As appreciated by those skilled in the art, the actual copies of the digital content 125 are not necessarily stored in the user's locker 120, but rather the locker 120 stores an indication of the rights of the user to the particular content 125 and a link or other reference to the actual digital content 125. Typically, the actual copy of the digital content 125 is stored in another mass storage (not shown). The digital lockers 120 of all of the users who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the lending server 150 can contain millions of files 125 containing digital content. It is also contemplated that the server 150 can actually he comprised of several servers with access to a plurality of storage devices containing digital content 125. As further appreciated by those skilled in the art, in conventional licensing programs, the user does not own the actual copy of the digital content, but has a license to use it. ⁻Hereinafter, if reference is made to “owning” the digital content, it is understood what is meant is the license or right to use the content.

The cloud 150 further has an Analytics section 160 that is used, as further described below, to derive data relating to users' behavior with respect to specific content. Although shown as only interacting with a single user's digital locker 120, those skilled in the art recognize that Analytics section 160 can receive data from the digital lockers 120 of every user of the system 100. Analytics section 160 preferably includes both the software and control circuitry for accomplishing the functions described herein.

User 105 can access his or her digital locker 120 using a local device 130. Local device 130 is an electronic device such as a personal computer, an e-book reader, a smart phone or other electronic device that the user 105 can use to access the server 150. In a preferred embodiment, the local device has been previously associated, registered, with the user's account using user's account credentials. Local device 130 provides the capability for user 105 to download her copy of digital content 125 via her digital locker 120. After digital content 125 is downloaded to local device 130, user 105 can engage with the downloaded content locally, e.g., read the book, listen to the music or watch the video.

In a preferred embodiment, local device 130 includes a non-browser based device interface that allows user 105 to initiate the functionality of system 100 in a non-browser environment. Through the device interface, the user 105 is automatically connected to the server 150 in a non-browser based environment. This connection to the server 150 is a secure interface and can be through the telephone network 145, typically a cellular network for mobile devices. If user 105 is accessing his or her digital locker 120 using the Internet 140, local device 130 also includes a web account interface, Web account interface provides user 105 with browser-based access to his or her account and digital locker 120 over the Internet 140.

Control circuitry 190 can include any processing circuitry or processor operative to control the operations and performance of server 150. For example, control circuitry 190 can be used to run operating system applications, firmware applications, control the user interface 170. In one embodiment, the Analytics section 160 is incorporated into the control circuitry 190.

Memory 180 can include cache memory, semi-permanent memory such as RAM, and/or one or more different types of memory used for temporarily storing data. For example, memory 180 can be used for storing data used to operate the Analytics section 160, or any other type of data that can be stored in storage digital lockers or the content database 125. Further, memory 180 can include, for example, one or more tangible computer storage mediums including a hard-drive, solid state drive, flash memory, permanent memory such as ROM, magnetic, optical, semiconductor, paper, or any other suitable type of storage component, or any combination thereof. Memory 180 can store, for example, the software for implementing functions on server 150. The instructions for implementing the functions of the present invention may, as non-limiting examples, comprise non transient software and/or scripts stored in the computer-readable media 180.

The User interface section 170 is used to communicate with the users' devices 130. As described above, the user Interface 170 includes the software for a web based interface as well as a non-web based interface. User interface also includes the hardware operative to connect the server 150 to a communications network and to transmit communications, e.g., data to electronic devices 130 or to other devices within the communications network. The communication circuitry in user Interface 170 is operative to interface with the Internet 140 as well as a telephone network 145. User Interface 170 includes sufficient communications circuitry for simultaneously performing several communications operations using different communications networks, with a plurality of user devices 130.

Operationally, the users' devices 130 and the cloud infrastructure 150 work together using sourcing techniques and other algorithms (some deployed on the device 130 as described below) to identify the last interesting page in specific digital publications such as books, magazines or other electronic content. As described above, the cloud infrastructure 150 has an Analytics 160 collection and reporting capability. In a preferred embodiment, there are about 300 such analytics collected today regarding a user's behavior on system 100. One of the data collected by Analytics 160 is the page number last viewed by the user 105 in an eBook 125. The last viewed page data can be collected from the user's device 130 in real time if the device 130 is connected to the cloud 150 via the network, 140 or 145. Alternatively, the last viewed page data is recorded in the device 130 itself in connection with a particular book 125 and then subsequently uploaded to the cloud 150 the next time the user logs onto, connects, to the server 150. In a preferred embodiment, the analytic data collected from a user is stored in the user's digital locker 120. Analytic data in regard to a specific piece of content 125 can be stored separately, in parallel, in connection with the specific content 125.

In this preferred embodiment, the last page viewed data is collected and stored for every piece of digital content 125 that a user has on her device 130, and is reported to the central server 150 the next time the device 130 connects to the server 150. If the last page viewed data for a particular piece of digital content 125 has not changed since the last time it was reported, it need not be reported again. In this way, only changes in the last viewed page are reported to the server 150. Further, since the system allows digital content 125 owned a user to viewed on several different devices 130, e.g., an eReader, a mobile phone, a laptop, each of these devices 130 report the last viewed page for each of the digital content 125 viewed on the device 130, and the last viewed page for the content 125 can be synchronized, via the cloud, on each of the user's devices.

The last viewed page information is collected in the cloud 150 from multiple users 105 (sourcing) with respect to the various titles 125 that are part of the system 100. This last viewed page data from multiple users 105 is used to derive a statistical estimate of when most users exit a particular book 125 and never returning to it, i.e., the last interesting page. When a statistically significant number of sourcing data points for the last viewed pages have been collected from the multiple users 105, the system determines, with a high degree of confidence, that the last interesting page value has been ascertained. As further described below however, this last interesting page value is subject to revision through an iterative process as more last viewed page data is received from more users 1105. The last interesting page value is stored in association with the specific content 125 about which the last viewed page data was collected.

In the preferred embodiment, the last interesting page value is propagated back to the device 130 of any user 105 that currently has the specific content 125 loaded on her device 130. The device 130 can then use this last interesting page information to present the element on that page, as described herein. In a preferred embodiment, the last interesting page value is stored in the metadata of the content 125. When opening the content 125, the reader application on the device 130 can read the metadata and know where (when) to present the element, i.e., when the user reaches the last interesting page. Further, the most up to date last interesting page for a particular piece of digital content 125 is stored on the server 150 in connection with the master copy of the digital content 125, e.g., in its metadata. As appreciated by those skilled in the art, there can be several “master” copies of digital content 125 stored on the server 150, from which user copies are made. Thus, when a new user 105 downloads, e.g., purchases, the digital content 125, the last interesting page is already identified in the digital content 125.

For the initial set of users, before a statistically significant number of data points have been received, the system 100 will send their devices 130 a last interesting page value, which can be used to present the element. However, as described above, the value for the last interesting page is subject to revision as more and more last viewed page data is collected from the more and more users 105.

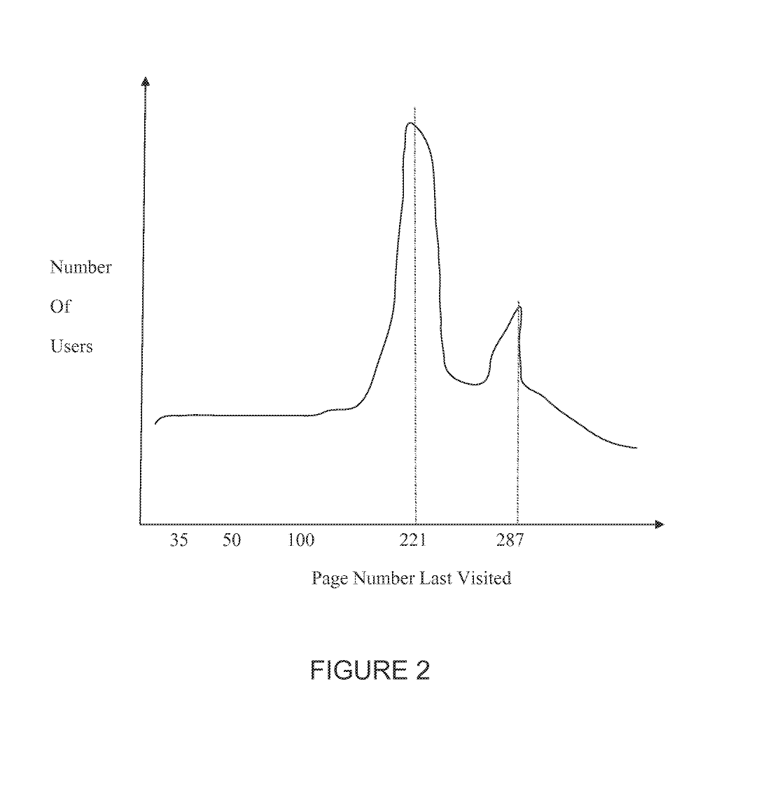

FIG. 2 is graph that illustrates the number of users and the last page they visited before closing a specific piece of digital content 125, e.g., an eBook or a publication. In the preferred embodiment, this data is collected in the cloud 150. The Y axis is the number of users and the X axis is the page that the user last viewed in the digital content 125 when the data was reported to the server 150. In the example illustrated in FIG. 2, the publication, e.g., an eBook, has approximately 300 pages in the total book. As seen towards the left of the graph, there is a relatively even distribution for last viewed page in the first 200 pages or so. As appreciated by any reader of books, the reader will typically have several reading sessions before she finishes a book. Each of these sessions will end on statistically random last viewed pages. There may be small spikes at chapter endings, which is a natural place to end a particular reading session. However, at page 221, there is a significant spike in the number of users that last viewed the eBook at this page. This spike indicates to the system that that page 221, to a relatively high degree of certainty, is the last interesting page of the eBook. The graph further shows a secondary spike of users last viewing the book at page 287. This could be, for example, the end of an Appendix or Afterword in the book.

In the preferred embodiment of the present invention, the system establishes page 221 as the last interesting page value. This value is then propagated back down to the devices 130 of all of the users 105 that that have that book loaded on their devices 130. The device 130 can then use the information to present the element as described above on page 221 of the eBook. Additionally, as described above, the last interesting page value is stored in the metadata of the master copy of the digital content 125 on the server 150 and is downloaded therewith when a new user 105 acquires the content 125.

There are several ways for the system to identify that user has not directly skipped to the last interesting page: if the user reaches the suspected last interesting page using a “GoTo” type navigation tool; or the user skips a chapter or certain chapters in between the last read chapter and the last interesting page and these intervening chapters have been marked as not-read. A chapter can be considered read if the user has opened the first and the last page of a chapter and has read/opened at least 5 pages (or x pages) with in that chapter, where x is the length of the chapter (if x<5).

In addition to the above described statistical manner in which to identify the last interesting page, there are also other ways to identifying the last interesting page on the device 130. If it is physically the last page in the book, then its easy to identify that page as the last interesting page. The last interesting page can also be identified as the last page in a particular chapter, most likely the last or the second to last chapter. The system can also collect data on how long a user spends on a particular page. Using this data, the average time spent on interesting and non-interesting pages are different. The last interesting page is typically closer towards the end of the book and the system knows the total number of pages in the book. Upon “nexting” (turning the page) to the last interesting page, most users rapidly read or skim the next one to five pages of the next chapter/content, before exiting the book. If the user is on the last page of a chapter and the next chapter's heading is something like “Appendix”, “Index”, it is likely the last page in the chapter is the last interesting page.

If the system misses putting the element on the last interesting page, e.g. a reward, advertisement, quiz, and subsequently determines the last interesting page for the eBook, the system can show a modified icon for the eBook in the user's library. This modified icon can serve to incentivize the user to re-open the book to claim the reward or show related content in which the user may be interested.

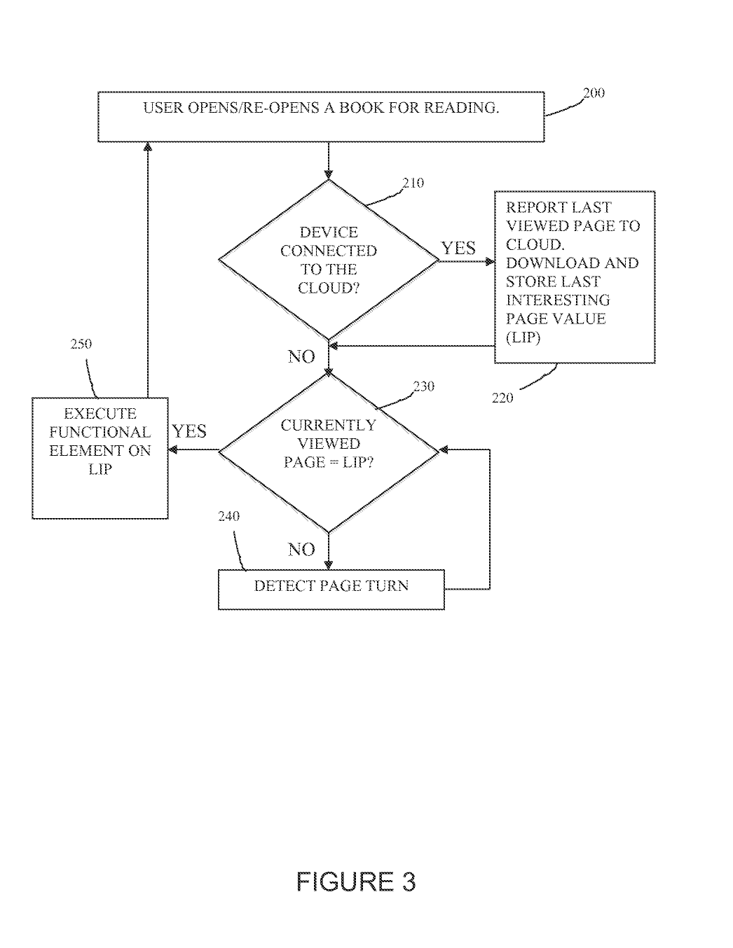

FIG. 3 illustrates a flow chart of a preferred method of the present invention. In act 200, the user 105 either opens a new book 125 or re-opens a book 125 that she had previously been reading. In act 210 the user's device 130 determines whether it is connected to the cloud, e.g., server 150. If the device 130 is connected to server 150, in act 220, the device 130 transmits the last page viewed in the current book (previously stored and preferably the last viewed page for any other digital content 125 whose last viewed page has changed since the last reporting to the server 150. While it is connected to the server 150, the device 130 downloads the value of the last interesting page for at least the currently viewed book 125 and preferably the last interesting page value for any other digital content 125 that is stored on the user's device 130. The server 150 knows which content 125 is stored on the device 130 as this information is stored in the user's digital locker 120 (see FIG. 1). As described above, the last interesting page value is preferably stored in the metadata of the digital content 125.

After the interaction with the cloud 150 is complete, or is the device is not currently connected to the cloud (“NO” out of decision 210) it is determined if the currently viewed page is equal to the value of the last interesting page. Again, this can be the last interesting page value just downloaded from the cloud 150, or can the last interesting page value previously stored in connection with the book 125. If the current page is not the last interesting page, the device 130, in act 240 waits for a page turn and then compares the new currently viewed page to the last interesting page value back in act 230. This iterative process repeats until the current page being viewed by the user is equal to the value of the last interesting page for the digital content 125.

Once the device 130 has determined that the currently viewed page is equal to the value of the last interesting page, in act 250, the device executes functional element on the last interesting page being displayed on the device 130. In a preferred embodiment, the content associated with the element to he executed is not stored in the digital content 125. The element content to be supplied on the last interesting page is preferably based on the book just read. The element content can also be based on the system's knowledge about the user 105 and her reading preferences and habits. This user profile information is stored in association with the user's digital locker 120 and is developed from the data processed by the Analytics section 160 (see FIG. 1)

In a preferred embodiment, the content for the last interesting page element is opened in the flow of the book 125 as the user reached the last interesting page. The system can insert into the book 125 flow, from the cloud, HTML+CSS+JavaScript code that embodies the last interesting page content element or elements. If the device 130 is not currently connected to the cloud, this last interesting page content and code can be stored on the device 130 and executed/displayed when the user reaches the last interesting page.

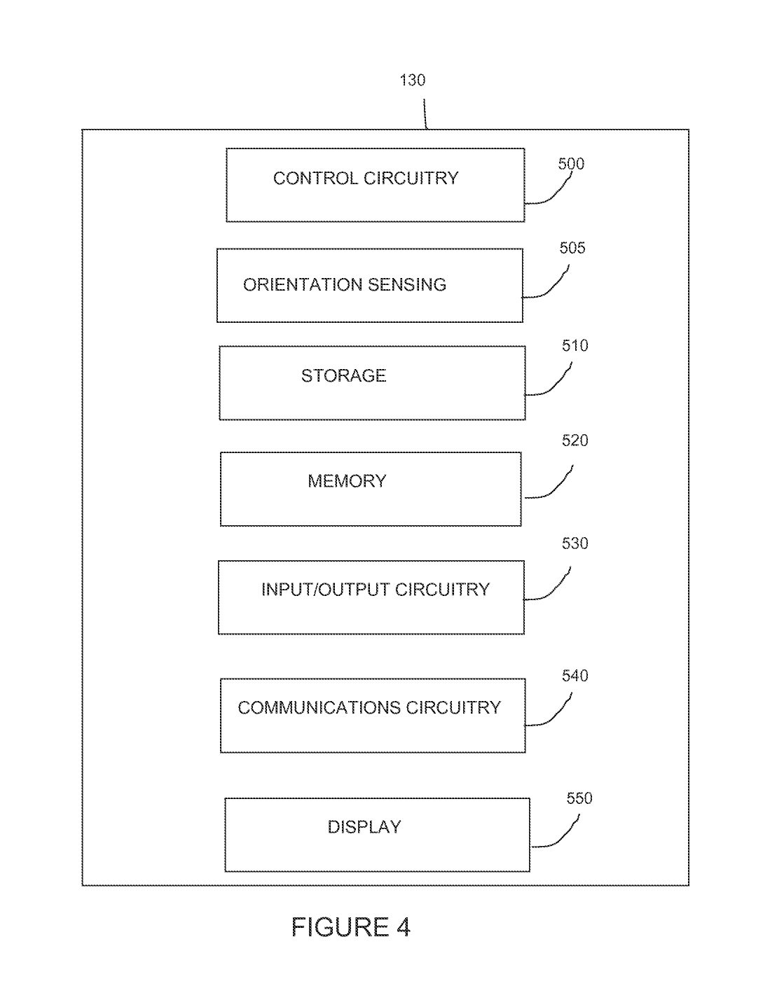

FIG. 4 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in FIG. 4, e.g., a power supply such as a battery, an input mechanism, etc.

Electronic device 130 can include any suitable type of electronic device. For example, electronic device 130 can include a portable electronic device that the user may hold in his or her hand., such as a digital media player, a personal e-mail device, a personal data assistant (“MA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can he used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 include orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUI), which drives the display 550 to present the GUI for the desired mode.

Storage 510 can include, for example, one or more tangible computer storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 430 to establish a wireless connection), subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise non transient software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i,e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in FIG. 3 as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronics device 130. In some embodiments, the display circuitry can include a coder/decoder (Codec) to convert digital media, data into analog signals. For example, the display circuitry or other appropriate circuitry within electronic device 130 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOW, or any other suitable protocol.

Electronic device 130 can include one more instances of communications circuitry 540 for simultaneously performing several communications operations using different communications networks, although only one is shown in FIG. 4 to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for identifying a last interesting page in digital content comprising:
distributing copies of the digital content from a central server to a plurality of devices;
receiving, at the central server, last viewed page data from at least some of the plurality of devices, the last viewed page data indicating the last page in the digital content that was viewed on the respective devices;
accumulating, at the central server, a statistically significant amount of last viewed page data;
determining, by the central server, a page in the digital content with the highest frequency in the last viewed page data, the determined page being denoted as a last interesting page value; and
transmitting the last interesting page value from the central server to the plurality of devices.

2. The method of claim 1, further comprising storing the last interesting page value in a master copy of the digital content on the central server.

3. The method of claim 2, wherein the act of storing further comprised storing the last interesting page value in metadata in the master copy of the digital content.

4. The method of claim 1, further comprising repeating the acts for a plurality of digital content.

5. A method for employing a last interesting page in digital content comprising:
opening the digital content on at east one device;
displaying pages of the digital content on a display of the at least one device;
connecting the at least one device to a central server;
transmitting last viewed page data from the at least one device to the central server, the last viewed page data, indicating the last page in the digital content that was viewed on the at least one device;
receiving, from the central server, a last interesting page value, the last interesting page value representing a page in the digital content that was last viewed by a plurality of devices;
comparing a current page being viewed to the last interesting page value;
if the current page does not equal the last interesting page value, repeating the comparing act for a new current page; and
if the current page equals the last interesting page value, displaying additional content on the current page.

6. The method of claim 5, further comprising storing the last interesting page value in metadata of the digital content.

7. The method of claim 6, wherein, when the device is not connected to the central server, using the last interesting page value stored in the metadata of the digital content.

8. The method of claim 5, further comprising periodically transmitting the last viewed page data from the device to the central server.

9. The method of claim 5, wherein the additional content is related to the digital content.

10. The method of claim 9, wherein the additional content includes at least one of feedback on the digital content, information about an author of the digital content, other digital content by the author.

11. The method of claim 9, further comprising providing a link in the additional content to the central server.

12. A system for identifying a last interesting page in digital content comprising:
a digital content database containing the digital content;
a memory that includes instructions for operating the system;
control circuitry coupled to the memory and coupled to the digital content database, the control circuitry capable of executing the instructions and is operable to at least;
retrieve the digital content from the digital content database;
distribute copies of the digital content to a plurality of devices;
receive last viewed page data from at least some of the plurality of devices, the last viewed page data indicating the last page in the digital content that was viewed on the respective devices;
accumulate a statistically significant amount of last viewed page data;
determine a page in the digital content with the highest frequency in the last viewed page data, the determined page being denoted as a last interesting page value; and
transmit the last interesting page value from the plurality of devices.

13. The system of claim 12, wherein the control circuitry is further operable to store the last interesting page value in a master copy of the digital content in the digital content database.

14. The system of claim 13, wherein the control circuitry stores the last interesting page value in metadata in the master copy of the digital content.

15. The system of claim 12, wherein the control circuitry is further operable to repeatedly execute the instructions for a plurality of digital content.

16. A system for employing a last interesting page in digital content comprising:
a memory that includes instructions for operating the system, and includes the digital content;
a display;
communication circuitry; and
control circuitry coupled to the memory, coupled to the display and coupled to the communication circuitry, the control circuitry capable of executing the instructions and is operable to at least:
open the digital content;
display pages of the digital content on the display;
connect the device to a central server using the communication circuitry;
transmit last viewed page data to the central server, the last viewed page data indicating the last page in the digital content that was viewed on the display;
receive, from the central server, a last interesting page value, the last interesting page value representing a page in the digital content that was last viewed by a plurality of devices;
compare a current page being viewed to the last interesting page value;
if the current page does not equal the last interesting page value, repeat the comparing act for a new current page; and
if the current page equals the last interesting page value, display additional content on the current page.

17. The system of claim 16, the control circuitry is further operable to execute the instructions to comprising storing the last interesting page value in metadata of the digital content.

18. The system of claim 17, wherein, when the device is not connected to the central server, the control circuitry is further operable to execute the instructions to use the last interesting page value stored in the metadata of the digital content.

19. The system of claim 16, wherein the control circuitry is further operable to periodically transmit the last viewed page data to the central server.

20. The system of claim 16, wherein the additional content is related to the digital content
